(19) United States
(12) Patent Application Publication
(10) Pub. No.: US 2014/0282886 A1
(43) Pub. Date: Sep. 18, 2014

(54) CONTENT LIST SHARING

(71) Applicant: TOLLSHARE, INC., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 13/827,187

(22) Filed: Mar. 14, 2013

(51) Int. Cl. H04L 29/06

(52) U.S. Cl. CPC H04L 63/10
USPC 726/4

(57) ABSTRACT

In embodiments, a server may receive an indication of a content list to be transferred from a first user equipment to a second user equipment. The content list may include information related to content such as books, music, movies, physical items, software, games, or other physical or non-physical goods or media. The server may identify the content in the content list, and then determine what rights, if any, the user of the second user equipment has to access the content in the content list. In some embodiments, the server may then accept a purchase request from one or both of the first user or the second user, and alter the permissions of the second user in response to the purchase request. Finally, the server may facilitate the transfer of the content list, and the content associated with the content list and accessible to the second user, to the second user equipment. Other embodiments may be described and/or claimed.

### BACKGROUND

Content lists, which may sometimes be referred to as playlists, may be used to manage diverse media including music, books, movies, software, games, physical goods, or other physical or non-physical content. Content lists may be useful because they allow a user to aggregate and manage their content into an order that makes sense to them.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example content list sharing system, in accordance with various embodiments.

FIG. 2 illustrates an example content list sharing process, in accordance with various embodiments.

FIG. 3 illustrates an example content list permission determination process, in accordance with various embodiments.

FIG. 4 illustrates an example process for facilitation the transmission of a content list and/or content to a user, in accordance with various embodiments.

FIG. 5 illustrates an example computing environment suitable for practicing the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Embodiments relate to methods and equipment for sharing content lists between users. Generally, the method may include a server that receives an indication of a content list to be transferred from a first user equipment to a second user equipment. The content list may include information related to content such as books, music, movies, software, games, physical goods, or other content. The server may identify the content in the content list, and then determine what content, if any, the second user already owns or has rights to. In some embodiments, the server may then accept an access request from one or both of the first user or the second user, and alter the permissions of the second user in response to the access request such that the second user gains right or permissions to access one or more pieces of content in the content list that the second user did not previously have rights or permissions to. Finally, the server may facilitate the transfer of the content list, and the content associated with the content list and accessible to the second user, to the second user equipment.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Referring now to FIG. 1, an example of a system for sharing a content list 100 is illustrated. In various embodiments, the content list as discussed herein may be a list of media, for example a playlist, and contain metadata and/or references to pieces of media, for example books, television, movies or other media. In some embodiments, the playlist may contain the media itself, while in other embodiments the playlist may only contain indications of the media. In other embodiments, the content list may be related to other non-physical content such as video games, software, etc. In some embodiments, the content list may be a user-generated content list containing content from multiple sources, for example as a mix of music from various artists and albums. In other embodiments, the content list may be a pre-defined content list such as all of the songs on a given album. In other embodiments, the content list may be a pre-defined content list such as only some of the songs on a given album. In other embodiments the content list may be defined as a trilogy or series of books or movies such that the content list contains the first movie, the second movie, etc. In some embodiments the content in the content list may be physical items such as goods in a store such as a convenience store, a grocery store, a department store, a “big-box” type store, or some other kind of store. All such described embodiments and other similar variations are contemplated herein.

In embodiments, terms such as “purchase,” “own,” “license,” etc. are used herein. It will be understood that those terms are intended to be generally interchangeable herein, and embodiments describing “owning” a piece of content may likewise relate to embodiments where the content is licensed, assigned, or other embodiments where a user gains access to content.

In various embodiments, the system 100 may include a server 105 with user permission data 110 stored thereon. Although the server 105 is illustrated in FIG. 1 as a single entity, in some embodiments the server 105 may comprise multiple hardware or software elements which are networked or otherwise coupled to one another such that data may be transmitted and received to and from each other. For example, in some embodiments the server 105 may comprise a group or cluster of servers.

In some embodiments, the user permission data 110 may be stored directly on the server 105, for example in a hard-drive, non-volatile memory (NVM) or some other form of storage on the server 105. In other embodiments the user permission data 110 may be stored on a device which is separate from, but accessible by, the server 105. For example, the user permission data 110 may be stored on networked servers, commonly referred to as “in the cloud,” which may be communicatively coupled with the server 105. The user permission data 110 will be discussed in greater detail below.

The server 105 may additionally include a content list resolver 108. In some embodiments, the content list resolver 108 and the user permission data 110 may be the same pieces of hardware, software, firmware or logic, while in other embodiments the content list resolver 108 and the user permission data 110 may be separate entities. In embodiments, the content list resolver 108 may be configured to compare a content list with information from the user permission data 110 to determine which items in the content list corresponds to data from the user permission data 110.

The server 105 may be coupled with a one or more user equipment 115a and/or 115b, for example via respective communication links 120a and/or 120b. In some embodiments the user equipment 115a and/or 115b may be cellular phones, portable computers, desktop computers, laptop computers, personal digital assistants (PDAs), or some other form of computing device usable by a user of the device. Hereinafter, user equipment 115a may be referred to as a first user equipment, and communication link 120a may be referred to as a first communication link. Similarly, user equipment 115b may be referred to as a second user equipment, and communication link 120b may be referred to as a second communication link. Similarly, the first user may be the owner and/or operator of the first user equipment 115a, and the second user may be the owner and/or operator of the second user equipment 115b. The designation of “first” or “second” is arbitrary and is not intended to prioritize or otherwise limit the first or second user equipment 115a or 115b or the first or second communication link 120a or 120b other than to serve as a distinguishing identifier.

Throughout the following specification, rights and permissions of, or data transfer to or from, a user and user equipment may be discussed. These distinctions are made for ease of understanding. In some embodiments, the transfer of a content list may occur between devices or possibly user accounts owned by the same user. In these embodiments, the access permissions of content may be tied to the specific user equipment. In other embodiments, the transfers may occur between different user equipment owned by different users. In general, the distinctions between the user and the user equipment is made for the ease of understanding, and the actual signal and data storage and propagation may be made at the user equipment level.

The first and second communication links 120a and 120b may be wired or wireless. For example, the first and second communication links 120a and 120b may be configured to transmit data between the server 105 and the first and second user equipment 115a and 115b over a wired network such as a public switched telephone network (PSTN), a circuit switched network, an ethernet connection, a USB connection, a firewire connection, or some other wired connection. Alternatively, the first and second communication links 120a and 120b may be wireless and involve a wireless connection such as an institute of electrical and electronics engineers (IEEE) 802.11 specified WiFi connection, an IEEE 802.16 specified Worldwide Interoperability for Microwave Access (WiMAX) connection, a third generation partnership project (3GPP) network such as a universal mobile telecommunications system (UMTS) connection, a long term evolution (LTE) connection, or some other wireless connection such as any other 2G/3G/4G/4.5G/5G connection known or hereafter developed. In some embodiments, the first and second communication links 120a and 120b may be a combination of two or more of the above listed network types.

Each of the first and second user equipment 115a and 115b may store respective first and second data 125a and 125b related to the content list and content data of the respective user of the first and second user equipment 115a and 115b. For example, first user equipment 115a may be owned and/or used by a first user and store data related to content lists developed or owned by the first user, as well as storing content accessible by the first user. Similarly, second user equipment 115b may be owned and/or used by a second user and store data related to content lists developed or owned by the second user, as well as storing content accessible by the second user. In some embodiments, the content may be stored on the first and second user equipment 115a and 115b itself, for example on a hard disk drive, an NVM, or a storage card of the first and second user equipment 115a and 115b. In alternative embodiments the content may be stored separately from the first and second user equipment 115a and 115b. For example, the content may be stored on a server that is separate from, but in communication with, the first and second user equipment 115a and 115b such that the first and second user equipment 115a and 115b may stream the content. As discussed above, this form of remote storage may be termed storing the content “in the cloud.” In some embodiments, the content may be physical content which is stored separately from the first and second user equipment 115a and 115b, for example in the form of books or other physical items. However, the first and second user equipment 115a and 115b may still store content lists related to the content.

As discussed above, the server 105 may store user permission data 110. The user permission data may be data that describes what content a user or user equipment is permitted to access. For example, if the first user equipment 115a is storing content in the first user content list and content data 125a, then the user permission data 110 for the first user may include an indication of the content that the first user or first user equipment 115a is able to access. Alternatively, if the first user is not actually storing the content on the first user equipment 115a, but instead is storing the content in the cloud or the content is physically separate from the first user equipment 115a, then the user permission data 110 for the first user may include indications of the content that the first user or first user equipment 115a is able to access or stream or otherwise owns. In other embodiments, the user permission data 110 may include data related to both locally stored content, for example content stored in the first user content list and content data 125a, and content stored in the cloud or otherwise physically separate from the first user equipment 115a. In some embodiments, the user permission data 110 may not be permanently stored on the server 105, but may be the result of a request or poll of the first user equipment 115a by the server 105 in specific instances which will be discussed in further detail below.

In some embodiments the first and second user equipment 115a and 115b may be configured to communicate with one another over a communication link 130. The communication link 130 may be wired, wireless, or some combination of the two such as described above with respect to first and second communication links 120a and 120b. In these embodiments the communication link may be configured to transmit data such as the first and second content or content data 125a or 125b from first user equipment 115a to second user equipment 115b. In other embodiments the first and second user equipment 115a and 115b may not be configured to communicate directly with one another but instead require transmission from, for example, first user equipment 115a to the server 105 over first communication link 120a, and then a second transmission from the server 105 to second user equipment 115b over second communication link 120b. In some embodiments, the server may be located on or otherwise coupled with or a part of one or both of first user equipment 115a and/or second user equipment 115b.

In some embodiments, it may be desirable for a content list to be transmitted from first user equipment 115a to second user equipment 115b. For example, the first user may have a content list that they want to share with the second user. FIG. 2 depicts a process 200 of allowing the content list to be shared with the second user. Throughout the remainder of the description, embodiments may be described from the point of view of transferring a content list of the first user to the second user. The process may be reversed in other embodiments such that the content list of the second user is transmitted to the first user.

First, a server such as server 105 may receive a request to transfer the content list from the first user to the second user at 210. The request may come in the form of a signal from the first user via the first user equipment 115a, and be received over the first communication link 120a. Alternatively, the request may be a signal received from the second user via the second user equipment 115b over the second communication link.

The server 105 may then determine the permissions of the second user or second user equipment 115b to access the content in the content list at 220. Specifically, the server 105 may determine whether the second user or second user equipment 115b is able to access each piece of content in the content list, or whether the second user or second user equipment 115b may only access some of the content in the content list. In this context, access may refer to playing, reading, watching, running, physically interacting with, or otherwise using or experiencing the content. As noted above, access may be achieved through ownership, licensing, assignment, or some other transfer of ownership or access rights. In various embodiments, access may include modification of the content. The determination is described in further detail below in FIG. 3.

Finally, the server 105 may facilitate the transfer of the content list and/or the content that the second user or second user equipment 115b has permissions to access at 230. The facilitating the transfer will be described in greater detail with respect to FIG. 4.

FIG. 3 illustrates an example content list permission determination process 300, in accordance with various embodiments. In various embodiments, the process may include one or more implementations of operation 220 in FIG. 2. The process 300 may begin at operation 305 where the server 105 receives information related to the content list. The information may include a list of the content, for example pieces of media, software, games, or physical items that the content list relates to. Additionally, the content list may include metadata such as titles of pieces of content, the order of the content in the content list, the sequence of the content in the content list, or other information related to the content. For example, the metadata may include a list of tracks in an album, episodes in a television series, software version updates in a piece of software, etc. In some embodiments, the information in the content list may include names or other designations assigned to one or more of the pieces of the content by the first user or by some other entity. For example, if a user renames a piece of content, then the content list may include one or both of the original name and the user-given name. As described above, in some embodiments the content list may include the content itself.

The server 105, and particularly the content list resolver 108, may then compare the received content list against the user permission data 110 at 310 to determine whether the second user or second user equipment 115b already owns, licenses, has an assignment to, or otherwise has permission to access all of the content in the received content list. If the second user already has permissions to access all of the content, then the process may end because there may be no need to transfer any content, or permissions to access the content, to the second user. However, if the second user does not already own all of the content in the content list, then the server 105 may determine a subset of content in the content list that is not owned or otherwise accessible by the second user at 315. For example, if the content list is a media playlist of three songs, and the second user has permissions to access the first song, then the subset of content may include the second and third songs. Other subsets may likewise be determined at 315 for other types of physical or non-physical content.

If it is determined that the second user or second user equipment 115b does not have permissions to access all of the content in the content list, and thereby determines a subset of un-accessible content, then the system may then determine whether an access request has been received at 325. Specifically, the access request may be a request to purchase the permissions to access some or all of the pieces of content in the subset of the content list that the second user or second user equipment 115b does not already have permissions for. In other embodiments, the access request may simply be a request to provide the second user access permissions without a specific purchase transaction, for example through lending, assigning, licensing, etc.

The access request may be received from the first user equipment 115a, and arrive concurrently with the request to transfer the content or content list. For example, the request to transfer the content list may be initiated by the request from the first user to purchase the content, or part of the content, for the second user. In other embodiments, the request to transfer the content list may be initiated by the request from the first user to license the content, or part of the content, on behalf of the second user, for example in the case of software which is licensed rather than sold. In some embodiments, the first user may have already purchased access to, or otherwise granted rights to, some unspecified content on behalf of the second user, and thereby created a positive pre-paid balance in an account of the first user such that the permissions to access or otherwise use the content by the second user draws on that balance.

In some embodiments, the access request may result from a signal transmitted to the first user equipment 115a from the server 105 after the determination at 310. The signal may notify the first user that the second user or second user equipment 115b does not have all of the permissions necessary to access some or all of the pieces of content in the content list. In some embodiments, the signal may specifically notify the first user which pieces of content are already owned by, licensed by, or otherwise available to the second user or second user equipment 115b, and which pieces of content are not. The first user may then decide to purchase or provide licensing to some or all of the necessary permissions for the second user or second user equipment 115b to access the content in the subset. In some embodiments, the first user or the second user may be notified that the second user or second user equipment 115b does not have permission to access at least some of the subset of the content, and that access may be purchased by a single action or button press on the part of the first or second user or first or second user equipment 115a or 115b. In some embodiments, the access request may be delayed such that the first user or second user are notified that the second user or second user equipment 115b does not have permissions to access all of the content, however the first user or second user may make the access request after at least a portion of the content is transmitted to the second user equipment 115b, as explained in greater detail below with respect to FIG. 4.

In other embodiments, the server 105 may transmit a signal to the second user equipment 115b notifying the second user that the first user has indicated that they would like to share a content list with the second user. The signal may further notify the second user that the second user or second user equipment 115b does not have all of the permissions necessary to access all of the content in the content list. The second user may then decide to purchase some or all of the necessary permissions so that they may access the content. In some embodiments, payment information may accompany the access request. In other embodiments, payment may be drawn from an account associated with one or both of the first user or the second user, for example an online account, which may be pre-paid in some embodiments as described above. In other embodiments, the access request may begin a transaction process that results in payment being transmitted to the server.

If the server 105 determines that an access request has not been received, then the second user may not be allowed to access the content in the subset, and so the process 300 may end. However, if the server 105 determines that a purchase request has been received at 320, then the permissions of the second user or second user equipment 115b may be modified at 325. Specifically, the permissions of the second user or second user equipment 115b may be modified to indicate which additional piece(s) of content in the subset the second user or second user equipment 115b is able to access. The server 105 may then determine that the content list and all of the content related to the content list to which the second user or second user equipment 115b has permissions may be transferred to the second user equipment 115b at 330. In some embodiments, the transfer may be accomplished by the server 105, the first user equipment 115a, or by some other entity, as explained in greater detail below.

FIG. 4 illustrates an example process 400 for facilitating the transmission of a content list and/or content to a user equipment, in accordance with various embodiments. In various embodiments, the process 400 may include one or more implementations of operation 230 in FIG. 2. The process 400 may begin at 410 where the content list and permissions of the second user or second user equipment 115b are determined at the server 105. This may occur as a result of process 300, or concurrently with process 300. Specifically, the determination of the content list and permissions of the second user at 410 may overlap or otherwise be part of the determination of the content list and the content in the content list at 330 if the determination at 410 is occurring in a server 105. Alternatively, the determination at 410 may occur at the first user equipment 115a in other embodiments. An indication may optionally then be transmitted by the server 105 or the first user equipment 115a to the second user equipment 115b at 420 indicating that a content list and/or content in the content list is to be transmitted to the second user equipment 115b. In some embodiments, the indication may overlap elements 320 and 325 of FIG. 3, and prompt the above-discussed access request by the second user. In other embodiments the indication may not be transmitted to the second user or second user equipment 115b, and the transfer 300 of the content list may occur transparently to the second user. In some embodiments, the indication may take the form of a digital handshake between the server 105 and the second user equipment 115b, or the first user equipment 115a and the second user equipment 115b, such that the second user or the second user equipment 115b acknowledge that they are receiving or about to receive the content list and/or the content.

The server 105 may then facilitate the transfer of the content list and/or pieces of content to the second user and the second user equipment 115b at 430 and 440. In some embodiments, the server 105 may facilitate the transfer by acting as a conduit to receive the content list and/or the portions of the content to which the second user or second user equipment 115b has the necessary permissions from the first user equipment 115a, and then re-transmit the received content list and/or content to the second user equipment 115b. In other embodiments, the server 105 may facilitate the transfer by sending a signal or otherwise authorizing one or both of the first user equipment 115a and the second user equipment 115b to transfer or receive the content list and/or the pieces of the content to which the second user or second user equipment 115b has the necessary permissions. The first user equipment 115a may then transmit the content list and/or some or all of the content to the second user equipment 115b across the communication link 130 after receiving the authorization. In other embodiments, the indication from the first user equipment 115a may simply identify that the second user may receive the content if the content is a physical good such as an item at a physical store as described above. In other embodiments, the server 105 may simply send an indication to a third party, for example an employee at a department store or a server of another company, that the content may be transferred to the second user or the second user equipment 115b.

In some embodiments, if the content is digital, then the first user equipment 115a or the server 105 may analyze the existing content of the second user equipment 115b and determine where the content list and/or content should be stored on the second user equipment 115b. For example, if the content is music and contains directories for artists such as “Artist 1” and “Artist 2,” then the transfer of the content may include placing content by Artist 1 or Artist 2 in the appropriate directories. In some embodiments, the analysis of the existing content of the second user equipment 115b may involve analysis of data such as the names of relevant musicians or album names, as well as arbitrary designators such as “favorites,” information related to moods, etc. For example, the second user equipment 115b may have a playlist related to “working out,” and any media or playlists related to “working out” from the server 105 or the first user equipment 115a may be stored in the “working out” directory of the second user equipment 115b. These names and designations are for the purposes of this discussion only, and other names or designations may be used in other embodiments.

In some embodiments, the first user equipment 115a or the server 105 may transmit the portion of the content that the second user or second user equipment 115b has the permissions to, and then additional permissions may be granted to the second user or second user equipment 115b as a result of a purchase or a gift on the part of the first or second users as described above with respect to elements 325 and 330. The first user equipment 115a or the server 105 may then transmit the content that the second user or second user equipment 115b required the permissions to access at 330.

In some embodiments, one or both of the first user and the second user may be able to share the content list on a social media platform. A social media platform may be a platform where users are able to share information with multiple people. Examples of social media platforms may include Twitter, Facebook, Myspace, Friendster, Spotify, bulletin board systems (BBSs) or other platforms. In some embodiments, users of the social media platform may be able to access, save, and/or alter the content list, for example by including new content in the content list or deleting content from the content list. In other embodiments, the content list may be the content list in FIG. 2, etc. For example, the second user may post the content list to the social media platform as a “wishlist,” and then the first user may decide to fulfill that wishlist for the second user using the processes described herein.

In some embodiments the social media platform or another entity may track the content lists and reward users that post, alter, or add content to the content list on a social media platform. For example, if a user posts a content list with a piece of content, and another user of the social media platform purchases or licenses that piece of content or the permissions to access that piece of content, then the company that owns and publishes that content may reward the user that posted the content. Examples of such rewarding companies may include movie, book, or music artists, labels, or publishers.

In some embodiments a social media user may be able to access and sample a piece of content in the content list. For example, a user may post the content list on a social media site, and a user of the social media site may review the content list and choose a piece of content to sample, for example a song. In some embodiments the sample of the piece of content may be of lower quality. In other embodiments, the sample of the piece of content may continue to degrade as additional users sample it.

In certain embodiments, the social media platform or another entity may track published content lists and create statistics related to trends. The statistics may take the form of an interest graph which may be based upon one or more of the history, timeline, and receipt of content lists and actions related to the content lists. The actions may include tagging the content lists, such as altering metadata or associating users with the content lists, accessing the content lists, accessing content in the content lists, or other actions. For example, an entity may track the number of times a specific band, author, actor, or actress appears in the content lists.

In further embodiments, the entity tracking the content lists and creating the statistics may be able to associate additional items or merchandise with the content lists. For example, if a single user is posting multiple content lists containing songs by a certain band, then the entity may notify the user that a new album by that band is available and offer the album for sale. Alternatively, the entity may post an advertisement associated with the content lists related to the new album by the band. In other embodiments, if a user posts multiple content lists relating to books about golf, then the entity may alter the content lists or the text of the content lists to create an advertisement related to other items associated with golf, or to additionally include physical items such as golf clubs in the content list.

FIG. 5 illustrates, for one embodiment, an example computer system 500 suitable for practicing embodiments of the present disclosure. Computer system 500 may be one or more of server 105, first user equipment 115a or second user equipment 115b. As illustrated, example computer system 500 may include system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508. In various embodiments, the one or more processors 504 may be a processor core.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for system 500. In one embodiment, system memory 512 may include any suitable volatile memory, such as suitable dynamic random access memory (“DRAM”), for example.

System control logic 508, in one embodiment, may include one or more input/output (“I/O”) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 516 may include a storage resource physically part of a device on which the system 500 is installed or it may be accessible by, but not necessarily a part of, the device. For example, the NVM/storage 516 may be accessed over a network via the communications interface(s) 520.

System memory 512 and NVM/storage 516 may include, in particular, temporal and persistent copies of user permission data 110 or user content list and content data 125a and/or 125b. The copies of the user permission data 110 or user content list and content data 125 and/or 125b may be stored in content list control logic 524. The content list control logic 524 may further include instructions that when executed by at least one of the processor(s) 504 result in the system 500 practicing one or more of the processes 200, 300 or 400 described above. In some embodiments, the content list control logic 524 may additionally/alternatively be located in the system control logic 508.

Communications interface(s) 520 may provide an interface for system 500 to communicate over one or more network(s) and/or with any other suitable device. Communications interface(s) 520 may include any suitable hardware and/or firmware, such as a network adapter, one or more antennas, a wireless interface, and so forth. In various embodiments, communication interface(s) 520 may include an interface for system 500 to use NFC, optical communications (e.g., barcodes), BlueTooth or other similar technologies to communicate directly (e.g., without an intermediary) with another device.

For one embodiment, at least one of the processor(s) 504 may be packaged together with system control logic 508 and/or content list control logic 524 (in whole or in part). For one embodiment, at least one of the processor(s) 504 may be packaged together with system control logic 508 and/or content list control logic 524 (in whole or in part) to form a System in Package (“SiP”). For one embodiment, at least one of the processor(s) 504 may be integrated on the same die with system control logic 508 and/or content list control logic 524 (in whole or in part). For one embodiment, at least one of the processor(s) 504 may be integrated on the same die with system control logic 508 and/or content list control logic 524 (in whole or in part) to form a System on Chip (“SoC”).

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

In embodiments, a process may include receiving, at a computing device, an indication of a content list to be transferred from a first device to a second device, the content list including information related to a plurality of content; and determining, based at least in part on a set of permissions of a user of the second device, at least a portion of content in the plurality of content that may be accessed by the user of the second device to facilitate transfer of the content list and the portion of content to the second device. In some embodiments, the determining may be based at least in part on a comparison of the set of permissions of the user of the second device with a list of content of the second device. In embodiments, the determining may be based at least in part on when a user received a permission in the set of permissions. In embodiments, the portion of content may include a first portion of content not present on the second device, and the plurality of content may further include a second portion of content, the second portion of content being present on the second device. In embodiments, the process may further include determining that the portion of content is not currently present on the second device; determining that the user of the second device does not have permissions to access the portion of content; receiving, from a user of the first device, an access request related to the portion of content; and modifying, based at least in part on the access request, the permissions of the user of the second device such that the user of the second device has permission to access the portion of content. In embodiments, the user of the first device may be different than the user of the second device. In embodiments, the content in the portion of content may not be known to the user of the first device at the time of the access request. In embodiments, transfer of the content list may include a digital authentication procedure. In embodiments, the content may be media content.

In some embodiments, a device may include a receiver configured to receive a request from a first user to transfer content in a content list to a second user. The device may further include a content list resolver coupled with the receiver and configured to compare the content list to a list of content owned by the second user; identify a first portion of the content that is present in the list of content owned by the second user; and identify a second portion of the content that is missing from the list of content owned by the second user. The device may further include a transmitter coupled with the content list resolver and configured to facilitate transfer of the content list and the second portion of the content to the second user without transfer of the first portion of the content. In some embodiments, the receiver may be further configured to receive, prior to transfer by the transmitter, an access request from the first user, the access request being configured to provide the second user access rights to the second portion of content. In some embodiments, the content list resolver may be configured to compare the content list to the list of content owned by the second user based at least in part on a comparison of the set of permissions of the second user with the content list. In some embodiments, the list of content owned by the second user may be based at least in part on when a user received a permission in the set of permissions. In some embodiments, the transmitter may be further configured to perform a digital authentication procedure. In some embodiments, the content may include a plurality of media content. In some embodiments, the content list may include an order of the plurality of media content, a sequence of the plurality of media content, or metadata related to the plurality of media content, the metadata containing arbitrary designations for at least a piece of media content in the plurality of media content. In some embodiments, the device may be or include a network device, a personal digital assistant (PDA), a smartphone, a computing tablet, an e-reader, an ultrabook, a laptop computer, a desktop computer, a server, a set-top box, or a game console.

In some embodiments, a process may include receiving a purchase request from a first user to purchase content in a content list; comparing the content in the content list to a list of content owned by a second user; identifying, based in part on the comparing, a first portion of content in the content list that is not owned by the second user and a second portion of content in the content list that is owned by the second user; and facilitating transfer, based at least in part on the purchase request, of the first portion of content to the second user. In embodiments, the purchase request may be only for the first portion of content. In embodiments, the identifying may be based in part on when the second user received the second portion of content in the content list. In embodiments, the purchase request may be for the first portion of content in the content list and the second portion of content in the content list, and further the process may further include receiving an indication of a purchase of only the first portion of content, the purchase based at least in part on the purchase request. In embodiments, the content may include media content. In embodiments, the content list may include an order of the media content in the content list, a sequence of the media content in the content list, and/or metadata related to the media content in the content list, wherein the metadata includes an arbitrary designation for at least a piece of media content in the content list. In embodiments, the content list may include a content list created by the second user on a social networking platform. In embodiments, a transfer may include a digital authentication procedure.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method comprising:
receiving, at a computing device, an indication of a content list to be transferred from a first device to a second device, the content list comprising information related to a plurality of content; and
determining, based at least in part on a set of permissions of a user of the second device, at least a portion of content in the plurality of content that may be accessed by the user of the second device to facilitate transfer of the content list and the portion of content to the second device.

2. The method of claim 1, wherein the determining is based at least in part on a comparison of the set of permissions of the user of the second device with a list of content of the second device.

3. The method of claim 2, wherein the determining is based at least in part on when a user received a permission in the set of permissions.

4. The method of claim 1, wherein the portion of content comprises a first portion of content not present on the second device, and the plurality of content further comprises a second portion of content, the second portion of content being present on the second device.

5. The method of claim 1, further comprising:
determining that the portion of content is not currently present on the second device;
determining that the user of the second device does not have permissions to access the portion of content;
receiving, from a user of the first device, an access request related to the portion of content; and
modifying, based at least in part on the access request, the permissions of the user of the second device such that the user of the second device has permission to access the portion of content.

6. The method of claim 5, wherein the user of the first device is different than the user of the second device.

7. The method of claim 5, wherein the content in the portion of content is not known to the user of the first device at the time of the access request.

8. The method of claim 1, where transfer of the content list comprises a digital authentication procedure.

9. The method of claim 1, wherein the content comprises media content.

10. A device comprising:
a receiver configured to receive a request from a first user to transfer content in a content list to a second user;
a content list resolver coupled with the receiver and configured to:
compare the content list to a list of content owned by the second user;
identify a first portion of the content that is present in the list of content owned by the second user; and
identify a second portion of the content that is missing from the list of content owned by the second user; and
a transmitter coupled with the content list resolver and configured to facilitate transfer of the content list and the second portion of the content to the second user without transfer of the first portion of the content.

11. The device of claim 10, wherein the receiver is further configured to receive, prior to transfer by the transmitter, an access request from the first user, the access request being configured to provide the second user access rights to the second portion of content.

12. The device of claim 10, wherein the content list resolver is configured to compare the content list to the list of content owned by the second user based at least in part on a comparison of the set of permissions of the second user with the content list.

13. The device of claim 12, wherein the list of content owned by the second user is based at least in part on when a user received a permission in the set of permissions.

14. The device of claim 10, wherein the transmitter is further configured to perform a digital authentication procedure.

15. The device of claim 10, wherein the content comprises a plurality of media content.

16. The device of claim 15, wherein the content list comprises an order of the plurality of media content, a sequence of the plurality of media content, or metadata related to the plurality of media content, the metadata containing arbitrary designations for at least a piece of media content in the plurality of media content.

17. The device of claim 10, wherein the device comprises a network device, a personal digital assistant (PDA), a smartphone, a computing tablet, an e-reader, an ultrabook, a laptop computer, a desktop computer, a server, a set-top box, or a game console.

18. A method comprising:
receiving a purchase request from a first user to purchase content in a content list;
comparing the content in the content list to a list of content owned by a second user;
identifying, based in part on the comparing, a first portion of content in the content list that is not owned by the second user and a second portion of content in the content list that is owned by the second user; and
facilitating transfer, based at least in part on the purchase request, of the first portion of content to the second user.

19. The method of claim 18, wherein the purchase request is only for the first portion of content.

20. The method of claim 18, wherein the identifying is based in part on when the second user received the second portion of content in the content list.

21. The method of claim 18, wherein the purchase request is for the first portion of content in the content list and the second portion of content in the content list, and further comprising receiving an indication of a purchase of only the first portion of content, the purchase based at least in part on the purchase request.

22. The method of claim 18, wherein the content comprises media content.

23. The method of claim 22, wherein the content list comprises an order of the media content in the content list, a sequence of the media content in the content list, and/or metadata related to the media content in the content list, wherein the metadata includes an arbitrary designation for at least a piece of media content in the content list.

24. The method of claim 18, wherein the content list comprises a content list created by the second user on a social networking platform.

25. The method of claim 18, wherein a transfer comprises a digital authentication procedure.
